(19) United States
(12) Patent Application Publication
(10) Pub. No.: US 2022/0084492 A1
(43) Pub. Date: Mar. 17, 2022

(54) GENERATIVE MODEL ESTABLISHMENT METHOD, GENERATIVE MODEL ESTABLISHMENT SYSTEM, RECORDING MEDIUM, AND TRAINING DATA PREPARATION METHOD

(71) Applicant: YAMAHA CORPORATION, Hamamatsu-shi (JP)

(72) Inventor: Ryunosuke DAIDO, Hamamatsu-shi (JP)

(21) Appl. No.: 17/534,664

(22) Filed: Nov. 24, 2021

Related U.S. Application Data
(63) Continuation of application No. PCT/JP2020/020753, filed on May 26, 2020.

(30) Foreign Application Priority Data
May 29, 2019 (JP) 2019-099913

(51) Int. Cl. G10H 7/08; G10L 25/30

(52) U.S. Cl. CPC G10H 7/08; G10L 25/30

(57) ABSTRACT

A method analyzes a reference signal representing a sound in each of analysis periods to obtain a series of phase spectra and a series of amplitude spectra over the analysis periods; adjusts, for each respective analysis period, phases of each harmonic component in a respective phase spectrum to be a target value at a pitch mark corresponding to the respective analysis period; synthesizes a first sound signal over the analysis periods based on the adjusted series of phase spectra of the reference signal and the obtained series of amplitude spectra of the reference signal; prepares training data including first control data representing of generative conditions of the reference signal and the first sound signal synthesized from the reference signal; and establishes, through machine learning using the training data, the generative model that generates a second sound signal based on second control data representing generative conditions of the second sound signal.

### CROSS REFERENCE TO RELATED APPLICATIONS

This application is a Continuation Application of PCT Application No. PCT/JP2020/020753, filed May 26, 2020, and is based on and claims priority from Japanese Patent Application No. 2019-099913, filed May 29, 2019, the entire contents of each of which are incorporated herein by reference.

### BACKGROUND

### Technical Field

The present disclosure relates to the establishment of a generative model for use in the synthesis of sounds such as speech or musical tones.

### Background Information

Sound synthesis technologies for synthesizing various sounds such as speech or musical tones have been proposed. For example, International Publication No. 2018/048934 (hereafter, “WO 2018/048934”) discloses a technique for synthesizing speech using a generative model such as a deep neural network. Merlijn Blaauw, Jordi Bonada, “A NEURAL PARAMETRIC SINGING SYNTHESIZER,” arXiv (2017 Apr. 12) discloses a technique for synthesizing a singing voice using a generative model similar to that of WO 2018/048934. The generative model is established by machine learning using a voluminous number of sound signals as training data.

Training of machine learning generative models requires an extremely large number of sound signals, and an extremely long training time. Thus, there is room for improvement for increasing efficiency of such machine learning.

### SUMMARY

Accordingly, an object of the present disclosure is to increase efficiency in training of machine learning generative models used for generating sound signals.

In order to solve the above problem, a method for establishing a generative model according to one aspect of the present disclosure includes: analyzing a reference signal representative of a sound in each of a plurality of analysis periods to obtain a series of phase spectra and a series of amplitude spectra over the plurality of analysis periods; adjusting, for each respective analysis period, phases of each harmonic component in a respective phase spectrum among the series of phase spectra of the reference signal to be a target value at a pitch mark corresponding to the respective analysis period to obtain an adjusted series of phase spectra; synthesizing a first sound signal over the plurality of analysis periods based on the adjusted series of phase spectra of the reference signal and the obtained series of amplitude spectra of the reference signal; preparing training data including first control data representative of generative conditions of the reference signal and the first sound signal synthesized from the reference signal; and establishing, through machine learning using the training data, the generative model that generates a second sound signal based on second control data representative of generative conditions of the second sound signal.

A generative model establishment system according to another aspect of the present disclosure is a generative model establishment system having one or more memories; and one or more processors communicatively connected to the one or more memories and configured to execute instructions to: analyze a reference signal representative of a sound in each of a plurality of analysis periods to obtain a series of phase spectra and a series of amplitude spectra over the plurality of analysis periods; adjust, for each respective analysis period, phases of each harmonic component in a respective phase spectrum among the series of phase spectra of the reference signal to be a target value at a pitch mark corresponding to the respective analysis period to obtain an adjusted series of phase spectra; synthesize a first sound signal over the plurality of analysis periods based on the adjusted series of phase spectra of the reference signal and the obtained series of amplitude spectra of the reference signal; prepare training data including first control data representative of generative conditions of the reference signal and the first sound signal synthesized from the reference signal; and establish, through machine learning using the training data, the generative model that generates a second sound signal based on second control data representative of generative conditions of the second sound signal.

A computer-readable recording medium according to another aspect of the present disclosure stores a program executable by a computer to perform a method of: analyzing a reference signal representative of a sound in each of a plurality of analysis periods to obtain a series of phase spectra and a series of amplitude spectra over the plurality of analysis periods; adjusting, for each respective analysis period, phases of each harmonic component in a respective phase spectrum among the series of phase spectra of the reference signal to be a target value at a pitch mark corresponding to the respective analysis period to obtain an adjusted series of phase spectra; synthesizing a first sound signal over the plurality of analysis periods based on the adjusted series of phase spectra of the reference signal and the obtained series of amplitude spectra of the reference signal; preparing training data including first control data representative of generative conditions of the reference signal and the first sound signal synthesized from the reference signal; and establishing, through machine learning using the training data, the generative model that generates a second sound signal based on second control data representative of generative conditions of the second sound signal.

A method of preparing training data according to one aspect of the present disclosure is a method of preparing training data used in machine learning to establish a generative model for generating sound signals based on control data, the method including: analyzing a reference signal representative of a sound in each of a plurality of analysis periods to obtain a series of phase spectra and a series of amplitude spectra over the plurality of analysis periods; adjusting, for each respective analysis periods, phases of each harmonic component in a respective phase spectrum among the series of phase spectra of the reference signal to be a target value at a pitch mark corresponding to the respective analysis period to obtain an adjusted series of phase spectra; synthesizing a first sound signal over the plurality of analysis periods based on the adjusted series of phase spectra of the reference signal and the obtained series of amplitude spectra of the reference signal; and preparing training data including first control data representative of generative conditions of the reference signal and the first sound signal synthesized from the reference signal.

### BRIEF DESCRIPTION OF THE DRAWINGS

FIG. 1 is a block diagram illustrating a configuration of a sound synthesizer according to the first embodiment.

FIG. 2 is a block diagram illustrating a functional structure of the sound synthesizer.

FIG. 3 is a flowchart illustrating example steps of preparation processing.

FIG. 4 is an explanatory diagram showing adjustment processing.

FIG. 5 is a flowchart illustrating example steps of a generative model establishment processing.

FIG. 6 is a flowchart illustrating a part of the adjustment processing in a second embodiment.

### DETAILED DESCRIPTION

### A: First Embodiment

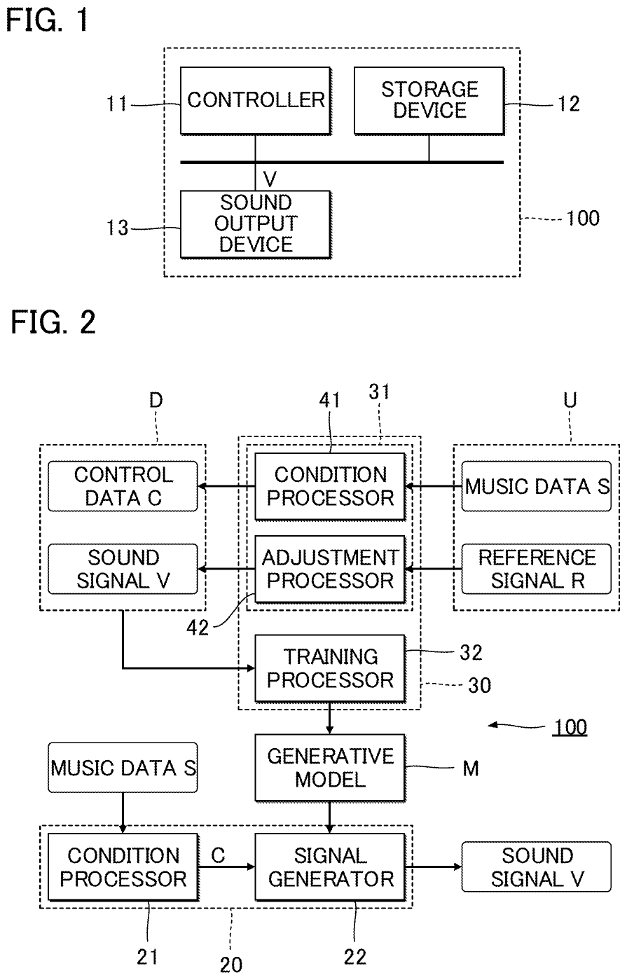

FIG. 1 is a block diagram illustrating a configuration of a sound synthesizer 100 according to an embodiment. The sound synthesizer 100 is a signal processing device that generates a freely-selectable synthesis sound. The synthesis sound is, for example, a singing voice sung virtually by a singer, or a musical instrument sound produced by an instrumentalist playing a virtual musical instrument. The sound synthesizer 100 is realized by a computer system that includes a controller 11, a storage device 12, and a sound output device 13. For example, an information terminal, such as a cell phone, smart phone, or personal computer can be used as the sound synthesizer 100.

The controller 11 comprises a single processor or multiple processors that control each element of the sound synthesizer 100. For example, the controller 11 comprises one or more processors such as a Central Processing Unit (CPU), Sound Processing Unit (SPU), Digital Signal Processor (DSP), Field Programmable Gate Array (FPGA), Application Specific Integrated Circuit (ASIC), etc. The controller 11 generates a sound signal V in a time domain. The sound signal V represents a waveform of a synthesis sound.

The sound output device 13 outputs synthesis sounds represented by the sound signal V generated by the controller 11. The sound output device 13 is, for example, a loudspeaker or a headphone. The D/A converter, which converts the sound signal V from a digital to analog signal, and the amplifier, which amplifies the sound signal V, are omitted from the figure for convenience. FIG. 1 illustrates a configuration in which the sound output device 13 is mounted to the sound synthesizer 100. However, the sound output device 13, which is provided separate from the sound synthesizer 100, may be connected to the sound synthesizer 100 either by wire or wirelessly.

The storage device 12 may comprise a single memory or multiple memories that store a program executed by the controller 11 and various data used by the controller 11. The storage device 12 comprises a known recording medium, such as a magnetic recording medium or a semiconductor recording medium. The storage device 12 may comprise a combination of multiple types of recording media. The storage device 12 may also be a portable recording medium detachable from the sound synthesizer 100, or an external recording medium (e.g., online storage) with which the sound synthesizer 100 can communicate.

FIG. 2 is a block diagram illustrating a functional configuration of the sound synthesizer 100. The controller 11 functions as a synthesis processor 20 by executing a sound synthesis program stored in the storage device 12. The synthesis processor 20 generates sound signals V by using a generative model M. The controller 11 also functions as a machine learner 30 by executing the machine learning program stored in the storage device 12. The machine learner 30 establishes by machine learning the generative model M used by the synthesis processor 20.

The generative model M is a statistical model for outputting a sound signal V based on control data C. In other words, the generative model M is a trained model that has learned a relationship between the control data C and sound signals V. The control data C specifies conditions describing a synthesis sound (sound signal V). The generative model M outputs a series of samples that constitute the sound signal V based on a series of pieces of the control data C.

The generative model M may comprise a deep neural network. Specifically, various types of neural networks such as a Convolutional Neural Network (CNN) or a Recurrent Neural Network (RNN) are used as the generative model M. The generative model M may include additional elements, such as Long Short-Term Memory (LSTM) or ATTENTION.

The generative model M is realized by a combination of (i) a program that causes the controller 11 to perform an operation to generate sound signals V from control data C and (ii) a plurality of variables (specifically, weighting values and biases) that are applied to the operation. The variables that define the generative model M are set by machine learning (deep learning) using the learning function described above.

The synthesis processor 20 includes a condition processor 21 and a signal generator 22. The condition processor 21 generates control data C from music data S stored in the storage device 12. The music data S specifies a series of notes (i.e., a musical score) that constitutes a piece of music. The music data S comprises, for example, a series of pieces of data, each piece specifying a pitch and a sound period for a corresponding sound production unit. A sound production unit is, for example, a single note in a piece of music. However, a single note may be divided into a plurality of sound production units. For music data S used to synthesize a singing voice, a phoneme, or a phonemic identifier (e.g., a character representative of a sound) is specified for each sound production unit.

The condition processor 21 generates a piece of control data C for each sound production unit. The piece of control data C for each sound production unit specifies, for example, a sound period of the sound production unit and its relation to other sound production units (e.g., a context such as a difference in pitch between the subject sound production unit and one or more sound production units preceding or following the subject sound production unit). The sound period is specified, for example, by the start point of sound production (attack) and the start point of decay (release). In synthesizing a singing voice, the condition processor 21 generates a piece of control data C that specifies the phoneme of the sound production unit in addition to the sound period and its relation to other sound production units.

The signal generator 22 generates, using the generative model M, a sound signal V based on the control data C. Specifically, the signal generator 22 generates a series of samples comprising the sound signal V by sequentially inputting a plurality of pieces of control data C into the generative model M.

The machine learner 30 includes a preparation processor 31 and a training processor 32. The preparation processor 31 prepares a plurality of pieces of training data D (i.e., a training dataset). The training processor 32 trains the generative model M by machine learning using the plurality of pieces of training data D prepared by the preparation processor 31.

Each of the plurality of pieces of training data D consists of a corresponding pair of training control data C and training sound signal V. In each of the plurality of pieces of training data D, training control data C specifies conditions describing a corresponding training sound signal V contained in the same piece of training data D.

The training processor 32 establishes the generative model M by machine learning using the plurality of pieces of training data D. Specifically, the training processor 32 iteratively updates multiple variables of the generative model M so as to reduce errors (loss function) between (i) a sound signal V generated based on the training control data C of each piece of the plurality of pieces of training data D by a tentative generative model M and (ii) the training sound signal V in the same piece of the plurality of pieces of training data D. Thus, the generative model M learns a potential relationship between the training control data C and the training sound signal V in each piece of the plurality of pieces of training data D. Consequently, the trained generative model M is able to output a statistically valid sound signal V for unknown control data C under the learned relationship.

The preparation processor 31 generates a plurality of pieces of training data D from each of a plurality of pieces of unit data U stored in the storage device 12. Each of the plurality of pieces of unit data U consists of a corresponding pair of (i) music data S and (ii) a series of reference signals R. The music data S specifies a series of sound production units that constitutes a piece of music. The reference signals R correspond to the respective sound production units. In each piece of unit data U, the series of reference signals R represents a waveform of a sound produced by singing or performing a piece of music represented by a corresponding piece of music data S in the same piece of unit data U. Each of the reference signals R represents a waveform of a sound of a corresponding sound production unit. Singing voices produced by a large number of singers or instrumental sounds produced by playing of a musical instrument by a large number of instrumentalists are recorded in advance. A plurality of reference signals R each representing either a singing voice or an instrumental sound is stored in the storage device 12 together with respective pieces of music data S.

The preparation processor 31 includes a condition processor 41 and an adjustment processor 42. The condition processor 41 generates training control data C for each of the reference signals R from the music data S of each piece of unit data U in substantially the same manner as the condition processor 21, as described above.

The adjustment processor 42 generates a training sound signal V from each of the plurality of reference signals R. Specifically, the adjustment processor 42 generates a sound signal V by adjusting a phase spectrum of a reference signal R. In the storage device 12, a plurality of pieces of training data D generated from each of the plurality of pieces of unit data is stored. Each piece of training data includes: (i) control data C generated by the condition processor 41 for a sound production unit of the music data S of a piece of unit data; and (ii) a training sound signal V generated by the adjustment processor 42 from a reference signal R that corresponds to the sound production unit, from among the reference signals R of the same piece of unit data U.

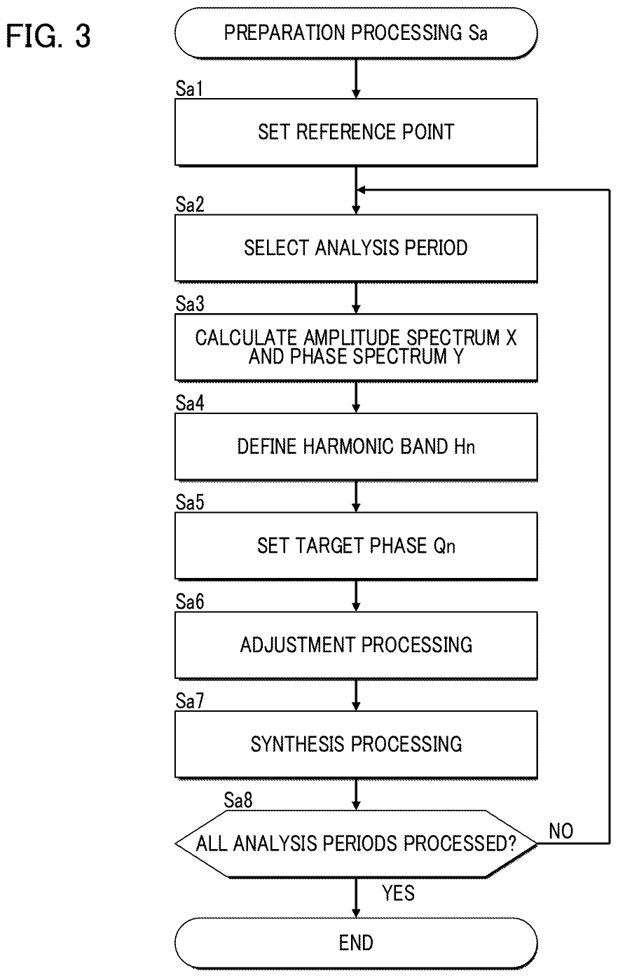

FIG. 3 is a flowchart illustrating an example procedure of processing Sa in which the adjustment processor 42 generates a training sound signal V from a reference signal R (hereafter, “preparation processing”). Preparation processing Sa is performed for each of the plurality of reference signals R.

The adjustment processor 42 sets a plurality of pitch marks for the reference signal R (Sa1). The pitch marks are reference points set on a time axis at intervals corresponding to a fundamental frequency of the reference signal R. For example, the pitch marks are set at intervals corresponding to the fundamental period, which is the reciprocal of the fundamental frequency of the reference signal R. Any known technology can be used to calculate the fundamental frequency of the reference signal R and set the pitch marks.

The adjustment processor 42 selects one of a plurality of analysis periods (frames) obtained by dividing the reference signal R on the time axis (Sa2). Specifically, one of the plurality of analysis periods is selected sequentially in chronological order. The following processes (Sa3-Sa8) are executed for one analysis period selected by the adjustment processor 42.

The adjustment processor 42 calculates an amplitude spectrum X and a phase spectrum Y for the analysis period of the reference signal R (Sa3). A well-known frequency analysis technique, such as a short-time Fourier transform, is used to calculate the amplitude spectrum X and the phase spectrum Y.

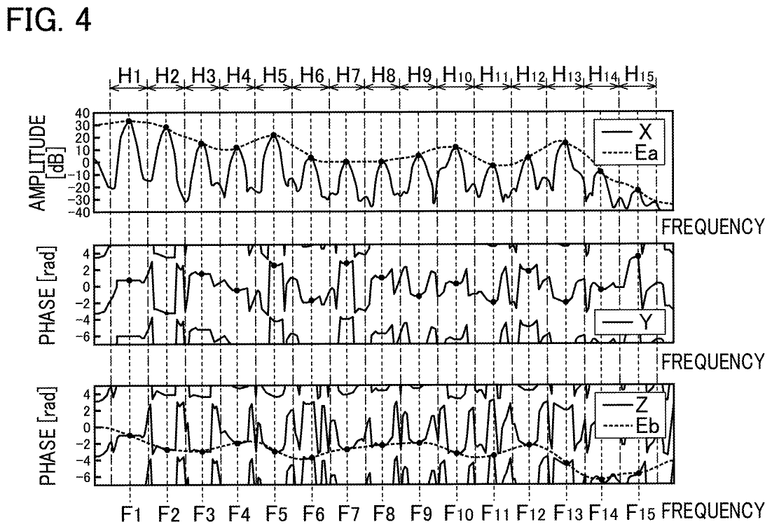

FIG. 4 illustrates the amplitude spectrum X and the phase spectrum Y for one analysis period. The reference signal R contains a plurality of harmonic components corresponding to different harmonic frequencies Fn (n is a natural number). The harmonic frequency Fn corresponds to the peak of the n-th harmonic component in the amplitude spectrum X. The harmonic frequency F1 corresponds to the fundamental frequency of the reference signal R. Each subsequent harmonic frequency Fn (F2, F3, . . . ) corresponds to the frequency of the n-th harmonic frequency of the reference signal R.

The adjustment processor 42 defines a plurality of harmonic bands Hn corresponding to different harmonic components on the frequency axis (Sa4). For example, a harmonic band Hn is defined on the frequency axis with a boundary midpoint between each harmonic frequency Fn and the harmonic frequency Fn+1 on the higher side of the harmonic frequency Fn. The method of defining the harmonic band Hn is not limited to the above example. For example, the boundary of a harmonic band Hn may be a point where the amplitude is minimized near the midpoint between the harmonic frequency Fn and the harmonic frequency Fn+1.

The adjustment processor 42 sets a target value (target phase) Qn for each harmonic band Hn (Sa5). For example, the adjustment processor 42 sets a target value Qn that corresponds to a minimum phase Eb in the analysis period of the reference signal R. Specifically, the adjustment processor 42 calculates, from the envelope Ea of the amplitude spectrum X (hereafter, the “amplitude spectrum envelope Ea”), a minimum phase Eb for the harmonic frequency Fn of each harmonic band Hn, to set the calculated minimum phase Eb as the target value Qn for the harmonic band Hn concerned.

The adjustment processor 42 calculates the minimum phase Eb, for example, by performing a Hilbert transform on the logarithmic value of the amplitude spectral envelope Ea. For example, the adjustment processor 42 first obtains a series of samples in the time domain by performing a discrete inverse Fourier transform on the logarithmic value of the amplitude spectral envelope Ea. Second, the adjustment processor 42 changes to zero the respective value of time-domain samples that correspond to negative timepoints on the time axis, and executes the discrete Fourier transform after doubling the samples corresponding to the respective timepoints excluding the origin and timepoints F/2 on the time axis (F is the number of points of the discrete Fourier transform). Third, the adjustment processor 42 extracts, as the minimum phase Eb, the imaginary part of the result of the discrete Fourier transform. The adjustment processor 42 selects as the target value Qn a value, at the harmonic frequency Fn, of the minimum phase Eb calculated by using the above procedure.

The adjustment processor 42 executes the processing Sa6 to generate a phase spectrum Z by adjusting the phase spectrum Y of the analysis period (hereafter, “adjustment processing”). The phase zf at the respective frequency fin the harmonic band Hn of the phase spectrum Z after the adjustment processing Sa6 is expressed by the following Equation (1).

$$zf = yf - ( yFn - Qn ) - 2 π f ( m - t ) \qquad ( 1 )$$

In Equation (1) yf denotes a phase at frequency fin the phase spectrum Y before adjustment. Accordingly, a typical phase yFn is a phase at the harmonic frequency Fn in the phase spectrum Y. On the right-hand side of the Equation (1) the second term (yFn−Qn) denotes an adjustment amount corresponding to the difference between the phase yFn at the harmonic frequency Fn in the harmonic band Hn and the target value Qn set for the harmonic band Hn. The operation of subtracting the adjustment amount (yFn−Qn) corresponding to the phase yFn at the harmonic frequency Fn in the harmonic band Hn from the phase yf is a process of adjusting the phases yf at respective frequencies fin the harmonic band Hn in accordance with the adjustment amount (yFn−Qn). The harmonic band Hn includes not only a harmonic component but also inharmonic components that occur between two adjacent harmonic components. By adjusting the phases yf at respective frequencies fin the harmonic band Hn by the adjustment amount (yFn−Qn), both harmonic and inharmonic components in the harmonic band Hn are adjusted in common by the adjustment amount (yFn−Qn). As will be understood from the above explanation, since the phase spectrum Y is adjusted while maintaining relative relations between the phases of the harmonic components and the phases of the inharmonic components, it is possible to generate a high-quality sound signal V for training.

In Equation (1), the symbol t denotes a point in time that has a predetermined relationship on the time axis with respect to the analysis period. For example, the time t is the midpoint of the analysis period. In Equation (1), the symbol m denotes a time of one pitch mark corresponding to the analysis period, from among the plurality of pitch marks set for the reference signal R. For example, among the plurality of pitch marks the time m is the time of a pitch mark that is closest to the time t of the analysis period. On the right-hand side of the Equation (1) the third term denotes a linear part of a phase that corresponds to a time of the time m relative to time t.

As will be understood from Equation (1), on the right-hand side of Equation (1) zero is derived from the third term when the time t coincides with the time m of the pitch mark. In other words, the phase zf, which is a phase after the adjustment, is set to a value obtained by subtracting the adjustment value (yFn−Qn) from the phase yf before the adjustment (i.e., zf=yf−(yFn−Qn)). Consequently, the phase yf (=yFn) at the harmonic frequency Fn is adjusted to the target value Qn. As will be understood from the above explanation, the adjustment processing Sa6 adjusts the phase spectrum Y of the analysis period such that the phase yFn of the harmonic component in the phase spectrum Y of the analysis period becomes the target value Qn at the pitch mark.

The adjustment processor 42 executes the processing Sa1 of synthesizing a time-domain signal from the phase spectrum Z generated in the adjustment processing Sa6 and the amplitude spectrum X of the reference signal R (hereafter, “synthesis processing”). Specifically, the adjustment processor 42 transforms a frequency spectrum defined by the amplitude spectrum X and the adjusted phase spectrum Z into a time-domain signal by use of, for example, a short-time inverse Fourier transform, and adds by partial superimposition the transformed signal to the signal generated for the immediately preceding analysis period. A time series of frequency spectra generated from the amplitude spectrum X and the phase spectrum Z corresponds to a spectrogram.

The adjustment processor 42 determines (Sa8) whether the above processing (adjustment processing Sa6 and synthesis processing Sa1) has been performed for each and every analysis period of the reference signal R. If there is an analysis period that has not yet been processed (Sa8: NO), the adjustment processor 42 selects a new analysis period immediately after the current analysis period (Sa2), and performs the above-described processing (Sa3-Sa8) for the analysis period. As will be understood from the above explanation, after adjustment by the adjustment processing Sa6 the synthesis processing Sa1 synthesizes a training sound signal V over multiple analysis periods based on the phase spectrum Z and the amplitude spectrum X of the reference signal R. When the process is completed for all analysis periods of the reference signal R (Sa8: YES), the preparation processing Sa for the current reference signal R is completed.

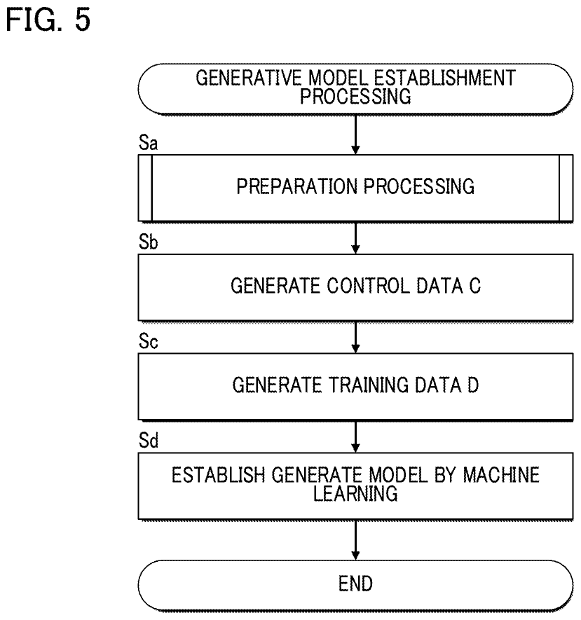

FIG. 5 is a flowchart illustrating an example procedure for the machine learner 30 to establish the generative model M (hereafter, “generative model establishment process”). For example, the generative model establishment process is initiated by an instruction from the user.

The preparation processor 31 (adjustment processor 42) generates a training sound signal V from a reference signal R of a respective piece of unit data U by preparation processing Sa including the adjustment processing Sa6 and the synthesis processing Sa7 (Sa). The preparation processor 31 (condition processor 41) generates training control data C for a corresponding sound production unit of the music data S of the respective piece of unit data U stored in the storage device 12 (Sb). The order of the generation of the training sound signal V (Sa) and the generation of the training control data C (Sb) may be reversed.

The preparation processor 31 generates a piece of training data D in which the training sound signal V generated from the reference signal R of the respective piece of unit data U and the training control data C generated for the corresponding sound production unit of the music data S of the respective piece of unit data U correspond with each other (Sc). The above processes (Sa-Sc) taken together are an example of a training data preparation method. A plurality of pieces of training data D generated by the preparation processor 31 is stored in the storage device 12. The machine learner 30 establishes the generative model M by machine learning using the plurality of pieces of training data D generated by the preparation processor 31 (Sd).

In the embodiment described above, for each of the plurality of reference signals R, the phase spectrum Y of each analysis period is adjusted such that the phase yFn of the harmonic component in the phase spectrum Y becomes the target value Qn at the pitch mark Therefore, the time waveforms of a plurality of training sound signals V that have similar conditions specified by the control data C are brought closer to each other by the adjustment processing Sa6. By the above configuration, machine learning of the generative model M progresses more efficiently compared with a method of using a plurality of reference signals R for which the respective phase spectrums Y are not adjusted. Therefore, it is possible to reduce a number of pieces of training data D required to establish the generative model M (and further, a time required for machine learning), and also reduce a scale of the generative model M.

Moreover, since the phase spectrum Y is adjusted with the target value Qn being the minimum phase Eb calculated from the amplitude spectral envelope Ea of the reference signal R, an audibly natural sound signal V can be generated by the preparation processing Sa. Therefore, it is also possible to establish a generative model M that can generate an audibly natural sound signal V.

### B: Second Embodiment

Description will be now given of the second embodiment. In the following embodiments and modifications, for elements whose functions are the same as those of the first embodiment, the same reference signs as those used in the description of the first embodiment are used, and detailed descriptions of the respective elements are omitted as appropriate.

In the first embodiment, the adjustment processing Sa6 is performed for each and every harmonic band Hn defined on the frequency axis. In the second and third embodiments, the adjustment processing Sa6 is performed only for some of the plurality of harmonic bands Hn.

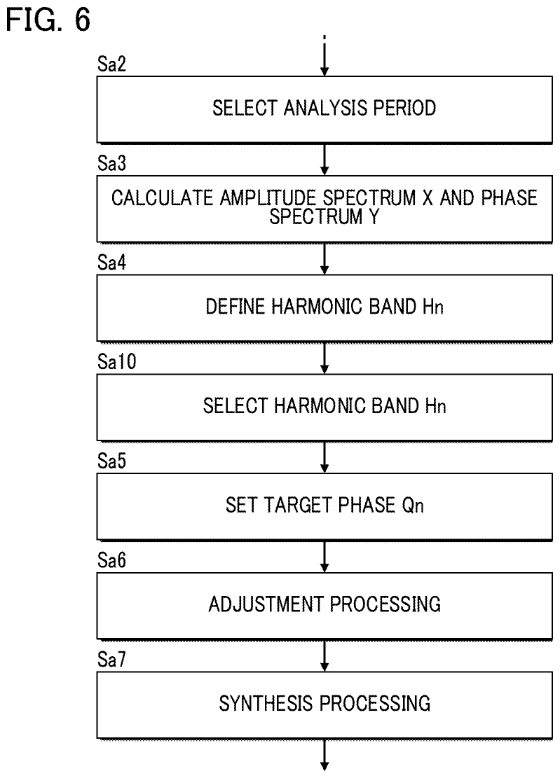

FIG. 6 is a flowchart illustrating a part of the preparation processing Sa in the second embodiment. The other part of the preparation processing Sa is the same as that in the first embodiment, which is shown in FIG. 3. After defining a plurality of harmonic bands Hn on the frequency axis (Sa4), the adjustment processor 42 selects from among the plurality of harmonic bands Hn two or more harmonic bands (hereafter, “selected harmonic bands”) Hn to be subject to the adjustment processing Sa6, (Sa10).

Specifically, from among a plurality of harmonic bands Hn, a harmonic band Hn with a harmonic component an amplitude of which exceeds a predetermined threshold is selected as the selected harmonic band Hn. The amplitude of the harmonic component is, for example, the amplitude (i.e., absolute value) at the harmonic frequency Fn in the amplitude spectrum X of the reference signal R. The harmonic band Hn may be selected dependent on an amplitude relative to a predetermined reference value. For example, the adjustment processor 42 uses as the predetermined reference value a value obtained by smoothing the amplitude spectrum X on the frequency axis or on the time axis, to calculate a relative amplitude of the harmonic component of the respective harmonic band Hn based on the reference value. The adjustment processor 42 then selects from among the plurality of harmonic bands Hn a harmonic band Hn for which the relative amplitude of the harmonic component exceeds a threshold.

The adjustment processor 42 sets the target value Qn for each of the plurality of selected harmonic bands Hn (Sa5). A target value Qn is not set for a harmonic band Hn that is not selected. The adjustment processor 42 performs the adjustment processing Sa6 for each of the plurality of selected harmonic bands Hn. The details of the adjustment processing Sa6 are the same as those in the first embodiment. The adjustment processing Sa6 is not performed for a harmonic band Hn that is not selected.

In the second embodiment, the same effects as those in the first embodiment are attained. In the second embodiment, the adjustment processing Sa6 is performed only for harmonic bands Hn for which the amplitude of the harmonic component exceeds the threshold. Therefore, it is possible to reduce the processing load for the adjustment processing Sa6 compared to a configuration in which the adjustment processing Sa6 is uniformly performed for all the harmonic bands Hn. In addition, since the adjustment processing Sa6 is performed only for harmonic bands Hn whose amplitude exceeds the threshold, it is possible to reduce the processing load for the adjustment processing Sa6 while maintaining efficient machine learning of the generative model M, compared to a configuration in which the adjustment processing Sa6 is performed for a harmonic band Hn whose amplitude is sufficiently small.

### C: Third Embodiment

In the third embodiment, the preparation processing Sa is performed in accordance with the flowchart of FIG. 6, as in the second embodiment. The other part of the preparation processing Sa in the third embodiment is the same as that of the first embodiment, which is shown in FIG. 3. In the second embodiment, the adjustment processing Sa6 is performed for harmonic bands Hn for which the amplitude (absolute value or relative value) of the harmonic component exceeds a threshold. The adjustment processor 42 of the third embodiment executes from among the plurality of harmonic bands Hn the adjustment processing Sa6 for harmonic bands Hn within a predetermined frequency band (hereafter, “reference band”). The reference band is a frequency band of a certain frequency range, and varies depending on a type of sound source represented by the reference signal R. Specifically, the reference band is a frequency band in which harmonic components (periodic components) predominate over inharmonic components (aperiodic components). For example, a frequency band of less than about 8 kHz is set as the reference band for voice.

After defining a plurality of harmonic bands Hn (Sa4), the adjustment processor 42 selects from among the plurality of harmonic bands Hn, as the selected harmonic bands Hn, harmonic bands Hn within the predetermined frequency band. Specifically, the adjustment processor 42 selects, as the selected harmonic bands Hn, a plurality of harmonic bands Hn, a harmonic frequency Fn of each of which takes a numerical value within the reference band. In the third embodiment, as in the second embodiment, the setting of the target value Qn (Sa5) and the adjustment processing Sa6 are performed for each of the plurality of selected harmonic bands Hn. The setting of the target value Qn and the adjustment processing Sa6 are not performed for the harmonic bands Hn that are not selected.

In the third embodiment, the same effects as those in the first embodiment are attained. Additionally, the third embodiment has an advantage in that, since the adjustment processing Sa6 is performed for the harmonic bands Hn in the reference band, it is possible to reduce a processing load of the adjustment processing Sa6 similarly to the second embodiment.

### D: Modifications

The following are examples of variations that can be included in each of the above embodiments. Two or more modes freely selected from the following examples may be combined as appropriate to the extent that they do not contradict each other.

(1) In each of the above described embodiments, the minimum phase Eb calculated from the amplitude spectral envelope Ea is set as the target value Qn. However, the method of setting the target value Qn is not limited to the above example. For example, a predetermined value common to multiple harmonic bands Hn may be set as the target value Qn. For example, a predetermined value (e.g., zero) set independently of the acoustic characteristics of the reference signal R is used as the target value Qn. According to the above configuration, since the target value Qn is set to a predetermined value, it is possible to reduce the processing load of the adjustment processing. In the above example, a common target value Qn is set across multiple harmonic bands Hn, but different predetermined values as target values Qn may be set for the respective harmonic bands Hn.

(2) In each of the above described embodiments, an example is given of a generative model M that generates a sound signal V based on the control data C. However, generative models (first and second generative models) may generate deterministic components and stochastic components of the sound signal V separately. The deterministic component is an acoustic component that is included in common in every sound produced by a sound source if the sound producing conditions such as a pitch or phoneme are the same. The deterministic component is also referred to as an acoustic component that predominantly contains harmonic components compared to inharmonic components. For example, a periodic component derived from the regular vibration of the vocal cords of a person who produces a sound is a deterministic component. On the other hand, a stochastic component is an acoustic component that is generated by stochastic factors in the sound producing process. For example, the stochastic component is an aperiodic acoustic component derived from turbulence in air in the sound producing process. The stochastic component is also referred to as an acoustic component that predominantly contains inharmonic components compared to harmonic components. The first generative model generates a series of deterministic components based on first control data representative of conditions for deterministic components. On the other hand, the second generative model generates a series of stochastic components based on second control data representative of conditions for stochastic components.

(3) Each of the above described embodiments provides an example of a sound synthesizer 100 including a synthesis processor 20. In another aspect of the present disclosure, there is provided a generative model establishment system with a machine learner 30. The synthesis processor 20 may or may not be provided in the generative model establishment system. The generative model establishment system may be realized in a form of a server device communicable with a terminal apparatus. Such a generative model establishment system distributes to terminal apparatuses a generative model M established by machine learning. A terminal apparatus has a synthesis processor 20 that generates a sound signal V using the generative model M distributed by the generative model establishment system.

In another aspect of the present disclosure, there is also provided a training data preparation apparatus with a preparation processor 31. The synthesis processor 20 may or may not be provided in the training data preparation apparatus. The training processor 32 may or may not be provided in the training data preparation apparatus. A server device communicable with a terminal apparatus may be realized as a training data preparation apparatus. The training data preparation apparatus distributes to terminal apparatuses a training dataset consisting of a plurality of pieces of training data D prepared by the preparation processing Sa. A terminal apparatus has a training processor 32 that establishes a generative model M by machine learning using the training dataset distributed from the training data preparation apparatus.

(4) As described in each of the above embodiments, the functions of the sound synthesizer 100 are realized by cooperation of a computer (e.g., the controller 11) and a program. The program according to an aspect of the present disclosure is provided in a form stored in a computer-readable recording medium and installed in a computer. The recording medium is, for example, a non-transitory recording medium, and an optical recording medium (optical disc) such as a CD-ROM is a good example, but any known form of recording medium such as a semiconductor recording medium or a magnetic recording medium is also included. A non-transitory recording medium includes any recording medium except transitory, propagating signals, and does not exclude a volatile recording medium. The program may also be provided to a computer in the form of distribution via a communication network.

(5) The artificial intelligence software for realizing a generative model M may be executed by an element other than CPU. For example, processing circuitry dedicated to neural networks, such as a Tensor Processor or Neural Engine, or a Digital Signal Processor (DSP) dedicated to artificial intelligence may execute the artificial intelligence software. Also, multiple types of processing circuits selected from the above examples may work in coordination to execute the artificial intelligence software.

### E: Appendix

The following configurations are derivable from the embodiments and modifications illustrated above, for example.

A method for establishing a generative model according to one aspect of the present disclosure (aspect 1) includes: analyzing a reference signal representative of a sound in each of a plurality of analysis periods to obtain a series of phase spectra and a series of amplitude spectra over the plurality of analysis periods; adjusting, for each respective analysis period, phases of each harmonic component in a respective phase spectrum among the series of phase spectra of the reference signal to be a target value at a pitch mark corresponding to the respective analysis period to obtain an adjusted series of phase spectra; synthesizing a first sound signal over the plurality of analysis periods based on the adjusted series of phase spectra of the reference signal and the obtained series of amplitude spectra of the reference signal; preparing training data including first control data representative of generative conditions of the reference signal and the first sound signal synthesized from the reference signal; and establishing, through machine learning using the training data, the generative model that generates a second sound signal based on second control data representative of generative conditions of the second sound signal. In the above aspect, for each of the plurality of reference signals, the phase spectrum of each analysis period is adjusted such that the phase of a harmonic component in the phase spectrum becomes the target value at a pitch mark. Consequently, the time waveforms of the plurality of sound signals with close conditions become closer to each other. According to the above method, machine learning by the generative model is more efficient compared to a method using multiple reference signals, phase spectra of which have not been adjusted. Therefore, the number of pieces of training data required to establish the generative model (and also the time required for machine learning) is reduced, and the scale of the generative model is also reduced.

In the first example (aspect 2), for respective frequency bands corresponding to respective harmonic components of the reference signal, phases of the phase spectrum in each respective frequency band corresponding to each respective harmonic component are adjusted by an adjustment amount in the adjusting step, and the adjustment amount for each respective frequency band is determined based at least on a difference between the target value and a typical phase that corresponds to a harmonic frequency of the harmonic component in the respective harmonic band. In the above aspect, the respective phase in the harmonic band is adjusted by the adjustment amount depending on the difference between the phase at the harmonic frequency and the target value. Therefore, the phase spectrum is adjusted while maintaining the relative relationship between the phase at the harmonic frequency and the phase at other frequencies, and as a result, it is possible to generate a high-quality sound signal.

In the second example (aspect 3), the method further includes calculating, for each frequency band corresponding to a harmonic component, from an envelope of the amplitude spectrum of the reference signal in each analysis period, a minimum phase value for the harmonic frequency of the harmonic component as the target value in the frequency band corresponding to the harmonic component. In the above aspect, the phase spectrum is adjusted using as the target value the minimum phase calculated from the envelope of the amplitude spectrum, so that an audibly natural sound signal can be generated.

In an example of the second method (aspect 4), the method further includes providing a common value as the target value in the respective frequency bands of the analysis period. In the above aspect, the target value is set to a predetermined value (e.g., zero), which reduces the processing load for adjusting the phase spectrum.

In an example of any of the second through fourth aspects, the method further includes selecting, from among the respective frequency bands, one or more frequency bands in each of which an amplitude of the harmonic component in the amplitude spectrum exceeds a threshold value, and in the adjusting step, adjusting phases of the phase spectrum only in the selected one or more frequency bands. In the above aspect, the phase spectrum is adjusted for harmonic bands in which the amplitude of the harmonic component exceeds the threshold. Accordingly, it is possible to reduce the processing load compared to a configuration in which the phase spectrum is adjusted uniformly for each and every harmonic band.

In any one of the second through fourth aspects, in the adjusting step, only phases of the phase spectrum in one or more predetermined frequency bands from among the respective frequency bands are adjusted. In the above method, since the phase spectrum adjustment is performed for harmonic bands only within the predetermined frequency band, the processing load is reduced compared to a configuration in which the phase spectrum adjustment is performed uniformly for each and every harmonic band.

The present disclosure is also realized as a generative model establishment system that executes the generative model establishment method of each of the above aspects, or as a program that causes a computer to execute the generative model establishment method of each of the above aspects.

A method for preparing training data according to one aspect of the present disclosure is a method of preparing training data used in machine learning to establish a generative model for generating sound signals based on control data, the method including: analyzing a reference signal representative of a sound in each of a plurality of analysis periods to obtain a series of phase spectra and a series of amplitude spectra over the plurality of analysis periods; adjusting, for each respective analysis periods, phases of each harmonic component in a respective phase spectrum among the series of phase spectra of the reference signal to be a target value at a pitch mark corresponding to the respective analysis period to obtain an adjusted series of phase spectra; synthesizing a first sound signal over the plurality of analysis periods based on the adjusted series of phase spectra of the reference signal and the obtained series of amplitude spectra of the reference signal; and preparing training data including first control data representative of generative conditions of the reference signal and the first sound signal synthesized from the reference signal.

### DESCRIPTION OF REFERENCE SIGNS

100 . . . sound synthesizer, 11 . . . controller, 12 . . . storage device, 13 . . . sound output device, 20 . . . synthesis processor, 21 . . . condition processor, 22 . . . signal generator, 30 . . . machine learner, 31 . . . preparation processor, 32 . . . training processor, 41 . . . condition processor, 42 . . . adjustment processor.

What is claimed:

1. A computer-implemented method for establishing a generative model, comprising:
analyzing a reference signal representative of a sound in each of a plurality of analysis periods to obtain a series of phase spectra and a series of amplitude spectra over the plurality of analysis periods;
adjusting, for each respective analysis period, phases of each harmonic component in a respective phase spectrum among the series of phase spectra of the reference signal to be a target value at a pitch mark corresponding to the respective analysis period to obtain an adjusted series of phase spectra;
synthesizing a first sound signal over the plurality of analysis periods based on the adjusted series of phase spectra of the reference signal and the obtained series of amplitude spectra of the reference signal;
preparing training data including first control data representative of generative conditions of the reference signal and the first sound signal synthesized from the reference signal; and
establishing, through machine learning using the training data, the generative model that generates a second sound signal based on second control data representative of generative conditions of the second sound signal.

2. The computer-implemented method according to claim 1,
wherein, for respective frequency bands corresponding to respective harmonic components of the reference signal, phases of the phase spectrum in each respective frequency band corresponding to each respective harmonic component are adjusted by an adjustment amount in the adjusting step, and the adjustment amount for each respective frequency band is determined based at least on a difference between the target value and a typical phase that corresponds to a harmonic frequency of the harmonic component in the respective harmonic band.

3. The computer-implemented method according to claim 2, further comprising:
calculating, for each frequency band corresponding to a harmonic component, from an envelope of the amplitude spectrum of the reference signal in each analysis period, a minimum phase value for the harmonic frequency of the harmonic component as the target value in the frequency band corresponding to the harmonic component.

4. The computer-implemented method according to claim 2, further comprising providing a common value as the target value in the respective frequency bands of the analysis period.

5. The computer-implemented method according to claim 2, further comprising selecting, from among the respective frequency bands, one or more frequency bands in each of which an amplitude of the harmonic component in the amplitude spectrum exceeds a threshold value, and
in the adjusting step, adjusting phases of the phase spectrum only in the selected one or more frequency bands.

6. The computer-implemented method according to claim 2,
wherein, in the adjusting step, only phases of the phase spectrum in one or more predetermined frequency bands from among the respective frequency bands are adjusted.

7. A system for establishing a generative model, the system comprising:
one or more memories; and
one or more processors communicatively connected to the one or more memories and configured to execute instructions to:
analyze a reference signal representative of a sound in each of a plurality of analysis periods to obtain a series of phase spectra and a series of amplitude spectra over the plurality of analysis periods;
adjust, for each respective analysis period, phases of each harmonic component in a respective phase spectrum among the series of phase spectra of the reference signal to be a target value at a pitch mark corresponding to the respective analysis period to obtain an adjusted series of phase spectra;
synthesize a first sound signal over the plurality of analysis periods based on the adjusted series of phase spectra of the reference signal and the obtained series of amplitude spectra of the reference signal;
prepare training data including first control data representative of generative conditions of the reference signal and the first sound signal synthesized from the reference signal; and
establish, through machine learning using the training data, the generative model that generates a second sound signal based on second control data representative of generative conditions of the second sound signal.

8. A non-transitory computer-readable recording medium storing a program executable by a computer to perform a method of:
analyzing a reference signal representative of a sound in each of a plurality of analysis periods to obtain a series of phase spectra and a series of amplitude spectra over the plurality of analysis periods;
adjusting, for each respective analysis period, phases of each harmonic component in a respective phase spectrum among the series of phase spectra of the reference signal to be a target value at a pitch mark corresponding to the respective analysis period to obtain an adjusted series of phase spectra;
synthesizing a first sound signal over the plurality of analysis periods based on the adjusted series of phase spectra of the reference signal and the obtained series of amplitude spectra of the reference signal;
preparing training data including first control data representative of generative conditions of the reference signal and the first sound signal synthesized from the reference signal; and
establishing, through machine learning using the training data, the generative model that generates a second sound signal based on second control data representative of generative conditions of the second sound signal.

9. A method of preparing training data used in machine learning to establish a generative model for generating sound signals based on control data, the method comprising:
analyzing a reference signal representative of a sound in each of a plurality of analysis periods to obtain a series of phase spectra and a series of amplitude spectra over the plurality of analysis periods;
adjusting, for each respective analysis periods, phases of each harmonic component in a respective phase spectrum among the series of phase spectra of the reference signal to be a target value at a pitch mark corresponding to the respective analysis period to obtain an adjusted series of phase spectra;
synthesizing a first sound signal over the plurality of analysis periods based on the adjusted series of phase spectra of the reference signal and the obtained series of amplitude spectra of the reference signal; and
preparing training data including first control data representative of generative conditions of the reference signal and the first sound signal synthesized from the reference signal.

10. The computer-implemented method according to claim 1, wherein the target value for each corresponding harmonic component of respective analysis periods among the plurality of analysis periods is a common value.

11. The computer-implemented method according to claim 2, wherein the typical phase corresponds to the harmonic frequency of the harmonic component at a peak of an amplitude spectrum in the respective harmonic band.
